(19) United States
(12) Patent Application Publication
(10) Pub. No.: US 2002/0074277 A1
(43) Pub. Date: Jun. 20, 2002

(54) Filter assembly, system and method for filtering fluids

(75) Inventor: Johannes Adrianus Thomassen, Blanes (ES)

Correspondence Address: STEINBERG & RASKIN, P.C., 1140 AVENUE OF THE AMERICAS, 15th FLOOR, NEW YORK, NY, 10036-5803, US

(73) Assignee: MEMBRANE CONCEPTS, S.L.

(21) Appl. No.: 09/994,488

(22) Filed: Nov. 24, 2001

Related U.S. Application Data
(63) Continuation-in-part of application No. 09/934,023, filed on Aug. 21, 2001.

(30) Foreign Application Priority Data
Jan. 19, 2001 (ES) U200100127
Jan. 19, 2001 (ES) P200100172
Nov. 24, 2000 (ES) U2001002987
Nov. 24, 2000 (ES) U2001002986

(51) Int. Cl. B01D 36/02

(52) U.S. Cl. 210/323.2

(57) ABSTRACT

A system for filtering fluids, which comprises a plurality of filter units, each unit including a membrane filter body with a plurality of filter elements. The filter elements are joined end to end and coaxially to one another using connecting elements between them. An outer shell houses the joined elements, the elements having peripheral portions configured for snug engagement within the outer shell. Members are provided at opposing ends of each unit for joining the units in series and end to end. Each member includes a filter head and a clamp associated with the filter head, the head having interior peripheral edges for engaging cooperating peripheral grooves in a corresponding end member of the filter unit. A ring gasket is provided inside the clamp such that the tightness of the connection between the filter head and the respective end member increases with increasing pressure in the filter unit. At least one of the filter units has a filter head formed as a single part, the part having an exterior radial duct, being closed off at one end, and being joined coaxially to the filter unit. Another of the filter units has a filter head is formed in two parts and joined coaxially to the filter unit. A first cylindrical part of the head has an exterior radial duct. A second cylindrical part of the head is joined coaxially to the first part and is closed off at one end. At the opposite end, an exterior axial duct is provided in communication with inside portions of the filter unit via an interior axial conduit. The first and second parts are held together by the clamp.

This application is a continuation-in-part of co-pending application Ser. No. 09/934,023, filed on Aug. 21, 2001.

### BACKGROUND OF THE INVENTION

The present invention relates generally to systems for physical and chemical separation and, more particularly, to an assembly, system and method for filtering fluids or the like.

Conventional fluid filtration systems accomplish physical separation, for example, by passing a fluid through a series of filter units. The fluid passes from one unit to another until it exits a final or end unit of the system, i.e., in a filtered state. Each unit typically includes at least one filter element, each with a body formed, for instance, in a cylindrical shape, by a spiral or microtube membrane. A shell or casing about the membrane maintains the filter body in its cylindrical shape at a generally uniform diameter throughout the length thereof. Two or more filter elements are then housed in a relatively rigid tube and joined end to end to form a filter unit. A cap or filter head is secured to the unit's intake and outlet ends, respectively, the filter head being joined to the tube interior by an annular gasket inside the mouth of the tube.

While found generally effective for filtration, these conventional arrangements also facilitate gradual build up of deposits and impurities on the filter elements as well as bacterial growth. Since this accumulation is generally irreversible, the individual filter elements and, eventually, the entire system are rendered ineffective. In addition, during normal use the pressure inside a particular unit often becomes high, causing the rigid tube housing the filter element to expand slightly. This, in turn, allows fluid to leak between the filter heads, the ring gasket and the tube. Moreover, because the filter element is manufactured separately, it is often not possible to consistently effect a fluid tight seal with the tube. Either way, when a filter unit consists of two or more such elements, this fluid leakage common to each element becomes magnified. Hence, a single defective filter unit can lead to degradation of the entire filtering operation.

An high performance filtration system is, therefore, desired that not only provides improved performance, but also long lasting, maintenance free filter elements.

### SUMMARY OF THE INVENTION

According to one aspect of the present invention, there is provided a system for filtering fluids which comprises a plurality of filter units, each unit including a membrane filter body with a plurality of filter elements. Connecting elements are provided for joining the filter elements end to end and coaxially to one another. An outer shell houses the joined elements, the elements having peripheral portions configured for snug engagement within the outer shell. Members are provided at opposing ends of each unit for joining them in series and end to end, each member including a filter head. A clamp associated with each filter head has peripheral edges for engaging cooperating peripheral grooves in a corresponding end member ofthe filter unit. A ring gasket is provided inside the clamp such that the tightness of the connection between the filter head and the respective end member increases with increasing pressure in the filter unit.

In accordance with another aspect of the present invention is a system for filtering fluids, which comprises a plurality of filter units, each unit including a membrane filter body with a plurality of filter elements. Connecting elements are provided for joining the filter elements end to end and coaxially to one another. An outer shell houses the joined elements, the elements having peripheral portions configured for snug engagement within the outer shell. Members are provided at opposing ends of each unit for joining them in series and end to end, each member including a filter head. A clamp associated with each filter head has a U section with interior peripheral edges for engaging cooperating peripheral grooves in a corresponding end member of the filter unit. A ring gasket is provided inside the clamp such that the tightness of the connection between the filter head and the respective end member increases with increasing pressure in the filter unit. In addition, each filter head is formed in two relatively cylindrical parts, the first part having an exterior radial duct and being connected coaxially to the filter unit. The second part is closed off at one end and, at the opposite end, has an exterior axial duct in communication with inside portions of the filter unit via an interior axial conduit. The second part is joined coaxially to the first, the two parts being held together by the clamp.

According to a further aspect of the present invention is a system for filtering fluids, which also comprises a plurality of filter units, each unit including a membrane filter body with a plurality of filter elements. Connecting elements are provided for joining the filter elements end to end and coaxially to one another. An outer shell houses the joined elements, the elements having peripheral portions configured for snug engagement within the outer shell. Members are provided at opposing ends of each unit for joining the units in series and end to end, each member including a filter head. A clamp associated with each filter head has a U section with interior peripheral edges for engaging cooperating peripheral grooves in a corresponding end member of the filter unit. A ring gasket is provided inside the clamp such that the tightness of the connection between the filter head and the respective end members increases with increasing pressure in the filter unit. Each filter head is formed as a single part, the part having an exterior radial duct, being closed off at one end, and joined coaxially to the filter unit.

In accordance with still another aspect of the present invention is a filter unit which includes a generally cylindrically shaped, membrane filter body of a plurality of filter elements. Connecting elements are provided for joining the filter elements end to end and coaxially to one another. A relatively rigid outer shell houses the joined elements, the shell comprising a glass fiber with a layer of resin molded thereon. Peripheral portions of the elements are configured for snug engagement within the outer shell. An outer surface of each unit end has a corresponding peripheral slot for joining one filter unit to another so as to permit the ingress and egress of fluid through a series of connected units.

According to yet another aspect of the present invention is a filter unit which includes a generally cylindrically shaped, membrane filter body comprising a plurality of filter elements. Connecting elements are provided for joining the filter elements end to end and coaxially to one another. A relatively rigid outer shell houses the joined elements, the elements having peripheral portions configured for snug engagement within the outer shell. A filter head is provided at each of the opposing ends of each unit for joining the units. A clamp associated with each filter head has interior peripheral edges for engaging cooperating peripheral grooves in a corresponding end member of the filter unit. A ring gasket is provided inside the clamp such that the tightness of the connection between the filter head and the respective end member increases with increasing pressure in the filter unit. In addition, each filter head has a first cylindrical part with an exterior radial duct and connected coaxially to the filter unit. The head also has a second cylindrical part closed off at one end and, at the opposite end, an exterior axial duct in communication with inside portions of the filter unit through an interior axial conduit. The second part is joined coaxially to the first, the first and second parts being held together by the clamp.

In accordance with yet a further aspect of the present invention is a filter unit which includes a generally cylindrically shaped, membrane filter body comprising a plurality of filter elements. Connecting elements are provided for joining the filter elements end to end and coaxially to one another. A relatively rigid outer shell houses the joined elements, the elements having peripheral portions configured for snug engagement within the outer shell. A filter head is provided at each of the opposing ends of each unit for joining the units. A clamp associated with each filter head has interior peripheral edges for engaging cooperating peripheral grooves in a corresponding end member of the filter unit. A ring gasket is provided inside the clamp such that the tightness of the connection between the filter head and the respective end member increases with increasing pressure in the filter unit. Each filter head is formed as a single part, the part having an exterior radial duct, being closed off at one end, and joined coaxially to the filter unit.

According to still another aspect of the present invention is a system for filtering fluids, which comprises a plurality of filter units, each unit including a membrane filter body with a plurality of filter elements. Connecting elements are provided for joining the filter elements end to end and coaxially to one another. A relatively rigid, outer shell houses the joined elements, the elements having peripheral portions configured for snug engagement within the outer shell. Members are provided at opposing ends of each unit for joining the units in series and end to end, each member including a filter head. A clamp associated with each filter head has interior peripheral edges for engaging cooperating peripheral grooves in a corresponding end member of the filter unit. A ring gasket is provided inside each clamp such that the tightness of the connection between the filter head and the respective end member increases with increasing pressure in the filter unit. At least one of the filter units has a filter head formed as a single part, the part having an exterior radial duct, being closed off at one end, and joined coaxially to the filter unit. At least one of the filter units has a filter head joined coaxially to the filter unit and a first cylindrical part with an exterior radial duct. A second cylindrical part of the filter head is joined coaxially to the first part and closed off at one end, and, at the opposite end, has an exterior axial duct in communication with inside portions of the filter unit through an interior axial conduit. The first and second parts are secured to one another by the clamp.

A further aspect of the present invention relates to a method for filtration of a fluid. The method comprises the step of initially directing a fluid flow in a first direction, the fluid passing through a first group of filter assemblies, the first group including a plurality of filter units, each unit having a series of membrane filter elements linked by connecting elements and filter heads. Next, the fluid filtered by the first group of assemblies is passed through a second group of filter assemblies, the second group including a plurality of filter unit. The fluid filtered by the second group is then passed through a third filter assembly, the third assembly including a plurality of filter unit. Finally, the direction of fluid flow is reversed, flowing in a direction opposite the first direction.

Yet another aspect of the invention is a method for re-circulation filtration. First, a plurality of filter assemblies are arranged in parallel for receiving a flow of fluid. Next, a fluid flow is directed in a first direction so as to direct the fluid through at least one of the filter assemblies. Finally, the fluid flow is directed in a reverse direction, back through the at least one filter assembly so as to prevent bacterial growth as well as the accumulation of waste deposits and impurities on the filter assemblies.

In accordance with still a further aspect of the present invention is a method of re-circulation filtration and regulated flow mixing. The method comprises the steps of arranging a plurality of filter assemblies in parallel for receiving a flow of fluid. Each assembly includes a series of filter units and each unit has a plurality of filter elements linked by connecting elements and filter heads. A fluid flow is directed in a first direction so as to pass the fluid through at least one of the filter assemblies. Valves are positioned at selected points of the filter assemblies to allow introduction and mixing of fluid flow supplied from several different entry points. This enables a user to adjust the filter system for optimum balance of fluid flow.

Accordingly, it is an object of the present invention to provide a high performance filtration system with filter elements that are long lasting and maintenance free.

Another object of the present invention is to provide a filtration system with leakproof connections between filter components.

A further object of the present invention is to provide an improved, multi-stage filtration system that allows ready removal of filter components for maintenance or replacement.

Still another object of the present invention is to provide an improved filtration system comprising a plurality of filter units adapted for arrangement in series and/or parallel.

Yet another object of the present invention is to provide a filtration system comprising a plurality of filter units with filter head connections between the units, the tightness of the filter head connections increasing with increasing pressure in the filter units.

Still a further object of the present invention is to provide an improved filter arrangement with different filter heads configurations that allow user-selected, custom assembly of a filtration plant, simply, economically and for optimum performance.

Another object of the present invention is to provide a membrane filter body that has a relatively low manufacturing cost.

A further object ofthe present invention is to provide an improved efficiency, membrane filter comprising two or more filter elements with corresponding connecting elements between them and filter heads on each end, the periphery of the filter fitting snugly within an outer shell so as to form a fluid tight seal.

Yet another object of the present invention is to provide a filtration system that minimizes bacterial growth on filter elements as well as gradual build up of deposits and impurities.

Still another object of the present invention is to provide a filtration system that utilizes reverse direction flow filtration in combination with flow mixture regulation for optimum cleansing of a fluid.

Another object of the present invention is to provide a simple, economical and reliable filtration system with filter components that may be connected directly to one another without the need for external piping.

Yet another object ofthe present invention is to provide a filtration system that is practical, effective and economical.

The invention will now be further described by reference to the following drawings which are not intended to limit the accompanying claims.

### BRIEF DESCRIPTION OF THE DRAWINGS

FIG. 1 is a schematic diagram of a fluid filtration system in a 4-2-1 arrangement, according to one aspect of the present invention;

FIG. 2 is a schematic diagram of a fluid filtration system showing the re-circulation circuit of FIG. 1;

FIG. 3 is a schematic diagram of a fluid filtration system showing a flow mixing arrangement, in accordance with one aspect of the present invention;

FIG. 4 is a sectional view of a filter unit with filter heads taken along line 4-4 of FIG. 1;

FIG. 5 is a sectional view of a filter unit without filter heads showing three filter elements, according to one aspect of the present invention;

FIG. 6 shows the filter unit of FIG. 5 with a relatively cylindrical outer shell, in accordance with one aspect of the present invention;

FIG. 7 is a side view of a filter unit, according to another aspect of the present invention;

FIG. 8 is diagram showing a configuration of connecting elements between adjoining filter elements and at the end members, in accordance with one aspect of the present invention;

FIG. 9 is a sectional view of a filter head formed as a single part and with no exterior axial duct, according to one aspect of the present invention;

FIG. 10 is a sectional view showing a connection between a filter head and one end of a filter unit, in accordance with the present invention;

FIG. 11 is a sectional view of a filter head formed in two parts, one of the parts being shown as a connection element between two filter units joined to one another, according to one aspect of the present invention;

FIG. 12 is a sectional view of a filter head formed in two parts at one end of a filter unit, in accordance with another aspect of the present invention;

FIG. 13 is an external side view of the filter head and unit of FIG. 12;

FIG. 14 is a plan view of the clamp set forth in FIG. 12;

FIG. 15 is a sectional view taken along line 15-15 of FIG. 14;

FIG. 16 is a side sectional view of the first part of the filter head shown in FIG. 12;

FIG. 17 is a side sectional view of the second part of the filter head shown in FIG. 12; and

FIG. 18 is a side sectional view of a filter head formed as a single part, according to one aspect of the present.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

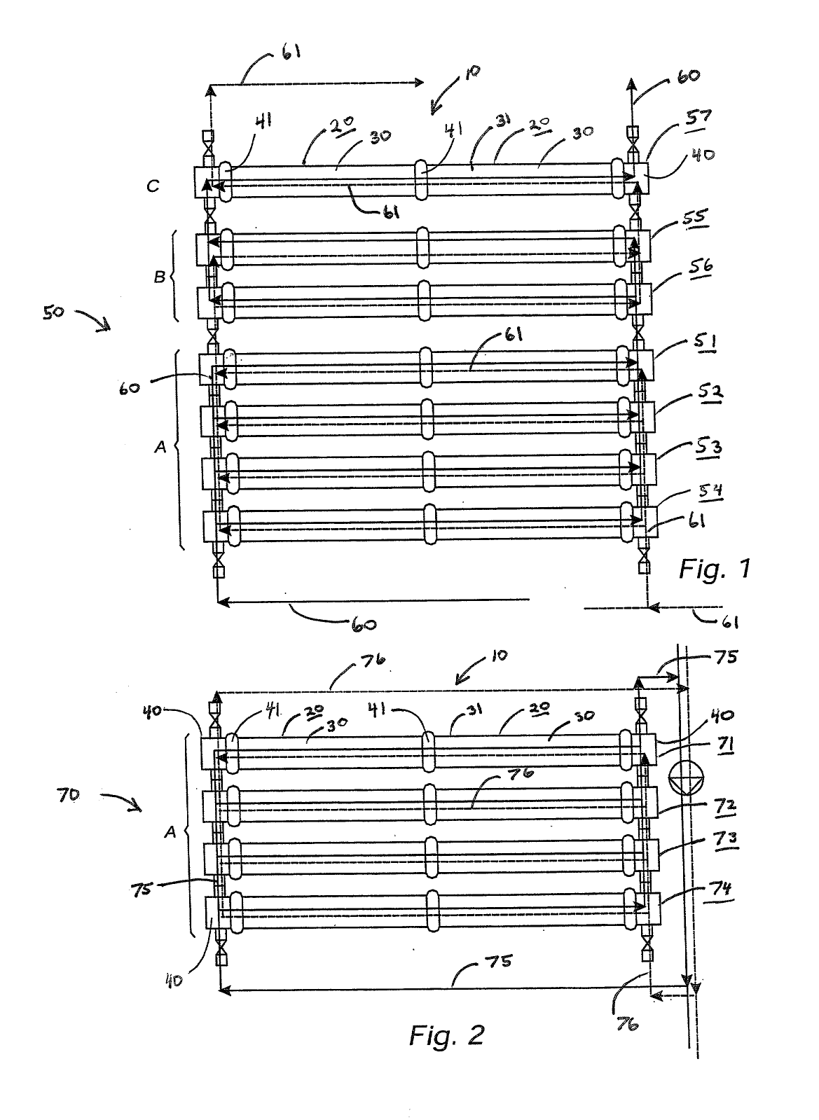

Referring now to the drawings and more particularly to FIGS. 1-18, there is shown generally a specific, illustrative system 10 for filtering fluids according to various aspects of the present invention. As shown in FIG. 1, the system comprises a plurality of filter units 20, each unit having a membrane filter body 30, such as a conventional spiral membrane or microtube membrane, with a series of filter elements 31. Anti-telescoping device (ATD) interconnecting members or connecting elements 32 are provided for joining the filter elements end to end and coaxially to one another, as best seen in FIGS. 4-6. The joined elements are desirably housed within an outer shell 33, e.g., a composite of filaments fibers such as glass fiber, carbon, acrylic or the like, and/or a glass fiber surrounded by a molded layer of resin, or the like. The elements have peripheral portions 34 figured for snug engagement within the shell. An objective of connecting elements 32 is to prevent telescoping or other unraveling (axially or laterally) of a spirally wound membrane.

Members 35 are provided at opposing ends 36, 37 of each unit forjoining them in series and end to end. Each member includes, or alternatively is characterized by, a filter head 40. Associated with the filter head, at least one clamp 41 is also provided for retaining the filter head on the corresponding member. The clamp has interior peripheral edges 42 for engaging cooperating peripheral grooves 43 in a corresponding end member of the filter unit. A ring gasket 44 is provided inside the clamp such that the tightness of the connection between the filter head and the respective end member increases with increasing pressure in the filter unit.

Generally speaking, and also illustrated in FIG. 1, is a filtration facility or plant 50 of the 4-2-1 type (a.k.a. a “Christmas Tree”) which provides for reversal of flow direction, in accordance with the present invention. The plant has a first filtering phase in which a selected fluid is fed to a first cluster or group of filter assemblies A. The group, for instance, comprises four membrane filters 51, 52, 53 and 54. During the next or second phase of filtration, the fluid passes through a second filter cluster or group of filter assemblies B, this one having of two membrane filters 55 and 56, respectively. Finally, the fluid enters a third phase which is preferably a single filter C such as membrane filter 57. A path of fluid flow 60, in accordance with the present invention, is illustrated by a first set of lines and arrows. Next, the fluid is fed into the plant in an opposite direction, this alternative or new path of flow 61 being demarcated by a set of dashed lines and arrows.

Referring now to FIG. 2, there is shown a re-circulation circuit type filtration facility or plant 70, according to one embodiment of the present invention. This plant includes a group of four filters A, i.e., membrane filters 71, 72, 73 and 74, for receiving a flow of fluid therethrough. Initially, fluid flows in a first direction 75 shown by solid lines and arrows, then in reverse 76, back through the filters, as indicated by dashed lines and arrows. This reversal of flow or flow inversion has been found beneficial in minimizing bacterial growth as well as the accumulation of waste deposits and impurities on filter elements. This, in turn, prolongs the functional life of the filter membranes.

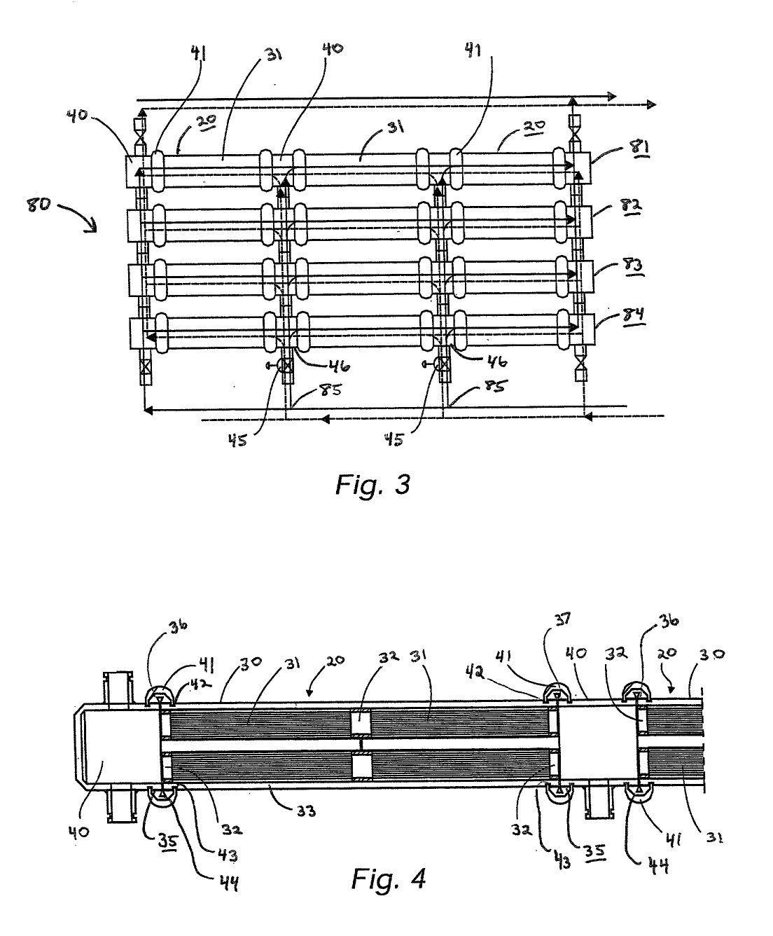

Shown in FIG. 3 is a re-circulation circuit type filtration facility, in combination with an arrangement for mixing flows. Specifically, this plant 80 comprises four rows of filter assemblies, i.e., membrane filters 81, 82, 83 and 84. As described above, each includes a series of filter units 20 and each unit, in turn, contains two filter elements 31 linked by connecting elements 32 and filter heads 40. Valves 45 are provided at selected connecting points 85 of the plant, e.g., at the entry for fluid intake of the middle two filter heads 46 on the bottom row. This arrangement permits mixing ofthe flow supplied to the plant from several different entry points. By so allowing fluid to be introduced in a user-selected, regulated fashion, an operator may adjust the system for optimum balance of flow within the filter system. Moreover, by controlling both volumetric flow rate and velocity of the flow in different filters of the plant, recovery of filtered fluid is maximized and effluent is produced of extraordinary quality.

Although the present invention has been shown and described with membrane type filters, e.g., spiral membrane or microtube membrane filters, it is understood that any filter type or other device for physical and/or chemical separation may be utilized, within the spirit and scope of the present invention.

Another feature of the present invention, as shown in FIGS. 1-3, is the ability to connect filter units directly to one another without the necessity of external conduits or other piping. This characteristic is facilitated by the novel filter unit and construction provided, namely, filter units, filter elements, filter heads and connections, according to the present invention, and the flexibility afforded thereby. In one embodiment, as illustrated above with reference to FIG. 4, each filter unit 20 comprises a series of filter elements 31, e.g., two, joined to one another end to end and coaxially by connecting elements 32, as described previously. Alternatively, each unit comprises three or four filter elements also joined to one another end to end and coaxially.

The resulting unit has end parts or members 35 at each end 36, 37, the complete unit being encased in the molded composite layer, such as the layer of glass fiber covered by a layer of molded resin provided herein. Specifically, in one embodiment, the layer is molded on the unit by selected winding of a resin-impregnated glass filament about the unit, the extent of such winding determining the thickness of the layer, in accordance with the desired filter requirements and operating pressure. After hardening, this composite layer forms a relatively rigid external surface or shell 33 on the filter body that is preferably cylindrical in shape. This is best seen in FIG. 7.

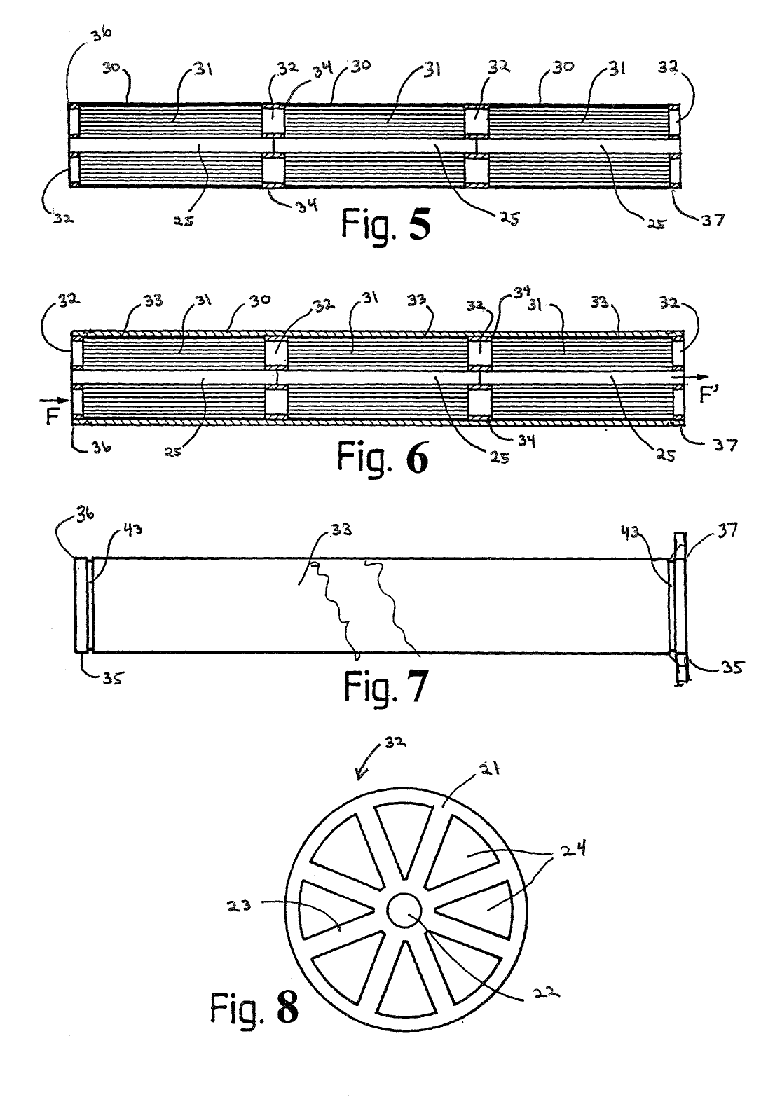

Turning now to another aspect of the present invention, there is shown generally in FIGS. 5-7 three filter elements connected to one another end to end via connecting elements so as to form a filter unit. Each end of the unit serves as an inlet and outlet, respectively, for receiving a flow of fluid, such ends each having end member or cap 35 fit thereon. To facilitate such fit and interconnection of filter units, slot or groove 43 is provided on the periphery of the filter body and in the vicinity of each of its ends. This feature simplifies connection of filter heads to the filter unit for the intake and exhaust of fluid.

Desirably, each filter element is formed by spiral filter membrane, e.g., of a conventional type, wrapped around a tube in the form of a cylinder. The periphery of the cylinder is, in turn, wrapped in a tape so as to maintain the spiral membrane in a generally cylindrical shape. To this end, it is preferred that the connecting elements and end members each be constructed of a polymeric material. In addition, as best seen in FIG. 8, each connecting element has an circular configuration comprising an annular exterior 21 with a hollowed central core or orifice 22 and spoke-like members 23 emanating radially from the walls of the core and radial openings 24 therebetween. With membrane type filters, according to the foregoing description, fluid preferably enters through one of the end members, as indicated by arrow F in FIG. 6, and exits in a filtered state through an axial tube 25 orifice of an end member at the opposite end. This is illustrated by arrow F′ in FIG. 6.

While the present invention has been shown and described in connection with operations for water purification/filtration, it is understood that the invention may be applied to physical or chemical separation systems for any fluid including gases, liquids or the like, according to the purpose for which the present invention is intended.

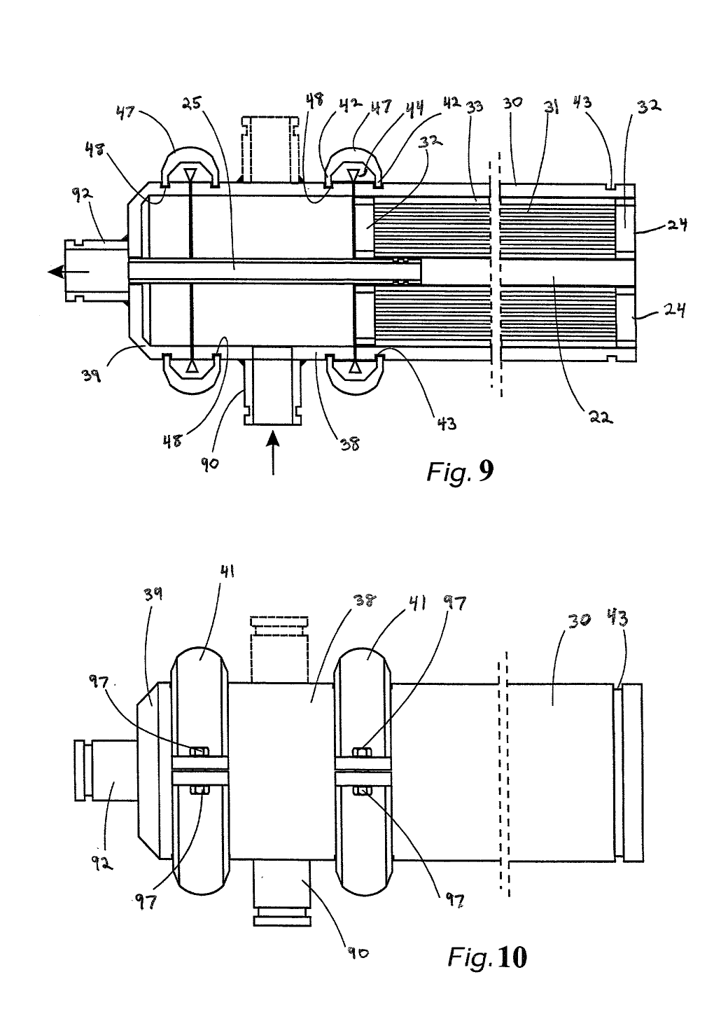

In another embodiment, as shown in FIGS. 9 and 10, the filter heads are desirably connected to the filter body by clamps 41. At least one clamp has a U section 47 that forms, for instance, two internal peripheral edges 42. These edges are adapted to fit in corresponding and cooperating peripheral grooves 43 near the ends of the filter body and in a peripheral groove 48 at the end of the filter head opposite the filter body. In addition, the clamp is provided with ring gasket 44, e.g., of a double-lip type, on its inside. The resulting connection afforded by such elements between the filter bodies also utilizes the securement forces exerted by the clamps.

According to still another embodiment of the present invention, each filter head is cylindrical in shape and is formed in two parts. As shown in FIGS. 13 and 14, a first cylindrical part 38 is joined coaxially to the filter body and provided with at least one exterior radial duct 90. A second cylindrical part 39 is connected coaxially to the first and closed at the end 91 opposite its connection with the first. Also at the closed end, an exterior axial duct 92 is provided as well as an axial tube 93 inside and joined to the exterior axial duct. The axial tube is also connected to the axial tube 94 of the adjoining filter body.

It is noted, according to various aspects of the present invention, that parts and components of the present invention, though generally described as having cylindrical shapes, may be formed in any suitable shape and/or configured for use in any orientation, within the spirit and scope ofthe present invention.

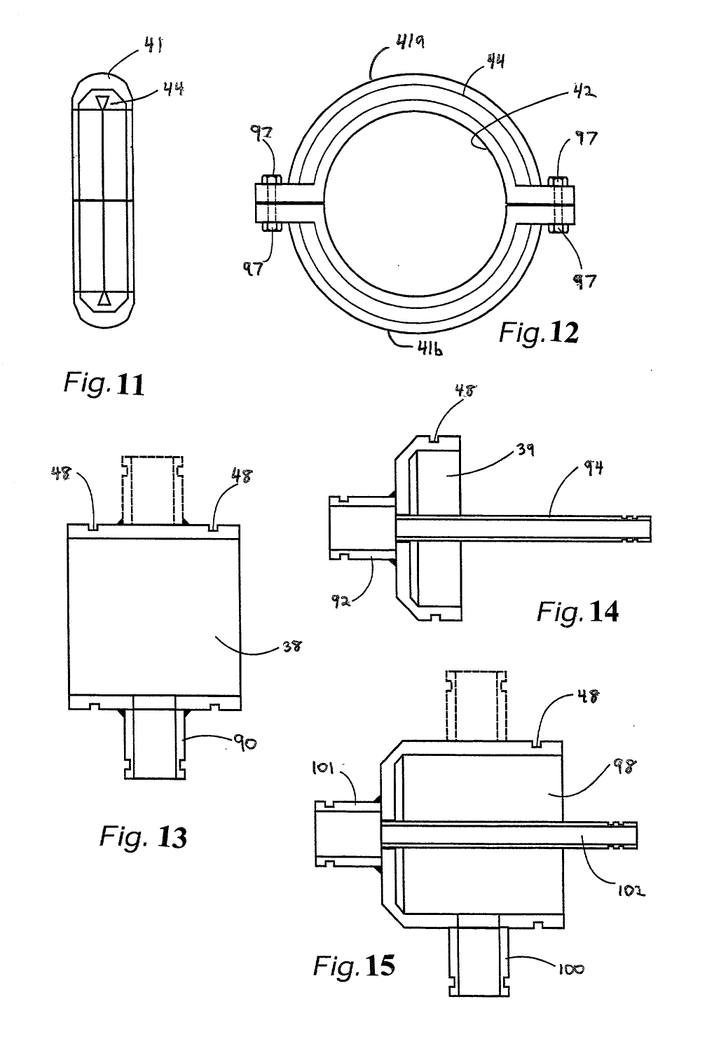

It is preferred that the first and second parts be joined to one another by clamp 41, as illustrated in FIGS. 11 and 12. The clamp fits in the peripheral grooves 95, 96 of the two parts, respectively. The clamps are preferably formed in two halves 41a, 41b which, in turn, are secured to one another by suitable fasteners 97. For example, the fasteners are screws and nuts that fit into end tabs on each clamp half, the end tabs being perforated and bent in a generally outward direction. This arrangement provides simplicity of assembly and manufacture, as well as lower cost.

According to a further aspect of the present invention, set forth in FIG. 15, the filter head is formed as a single part 98 and has a groove 99, radial duct 100, axial duct 101 and an interior axial tube 102. Fluid to be filtered enters via the radial duct and exits via the axial duct. By way of a like filter head fit to the other end of the filter by one of its ducts, excess unfiltered fluid may exit the filter arrangement. Optionally, such filter head has an outlet duct, alternatively or concurrently, for the exiting filtered fluid.

While the present invention is shown and described as having membrane element filtration units with particular features, it is understood that other suitable units and connecting arrangements may be utilized, within the spirit and scope of the present invention. Such unit and arrangement is described, for example, in a co-pending U.S. patent application, entitled MEMBRANE ELEMENT FILTRATION UNIT, Attorney Docket No. 949.1052, filed on Nov. 23, 2001 by Johannes Adrianus Thomassen, the disclosure of which is hereby incorporated by reference herein in its entirety.

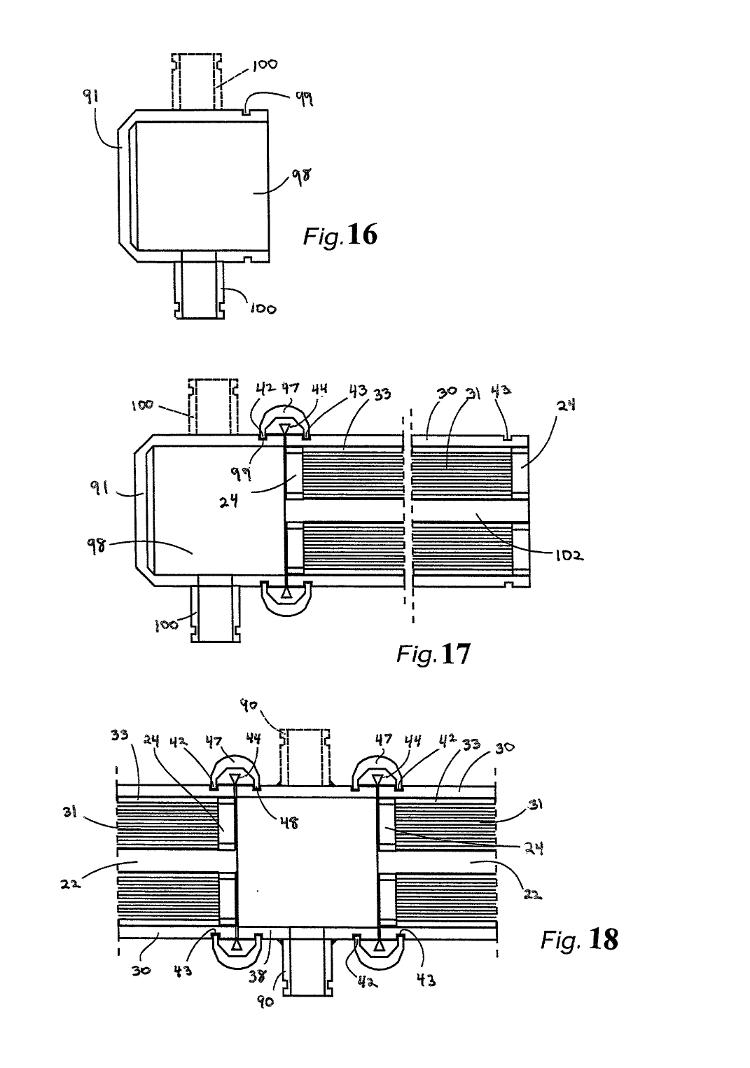

As shown in FIGS. 16-18, filter heads according to the present invention may also be used to connect one filter unit to another, as will be understood by those skilled in the art. Using the filter units described, depending on facility requirements and the plant so erected, fluid entry or exit occurs preferably through any of the radial ducts.

Alternatively or concurrently, a filtration facility is provided that utilizes, in combination, at least one of the filter heads having first and second parts 38, 39, respectively, joined to one another by the clamp, as illustrated in FIGS. 11 and 12, and at least one filter head formed as a single part 98 and having the aforementioned groove, radial duct, axial duct and interior axial tube, set forth in FIG. 15. In either arrangement, fluid to be filtered enters via a radial duct or an axial duct and may exit any such duct, within the spirit and scope of the present invention. By way of a like filter head fit to the other end of the filter by one of its ducts, excess unfiltered fluid may exit the filter arrangement. Optionally, such filter head has an outlet duct, alternatively or concurrently, for the exiting filtered fluid.

While the present invention has been described as having a shell formed by layer of glass fiber covered by a layer of molded resin, those skilled in the art will appreciate that other materials of construction may be used, depending on system requirements such as the fluid being filtered and/or the system environment, giving consideration to the purpose for which the present invention is intended.

Overall, the present invention advantageously provides a high performance filtration system with increased longevity filter elements and leak-free connections between filter components, regardless of operating pressure. Its improved, multi-stage filtration allows ready removal of filter components for replacement or maintenance. A plurality of filter units are provided which are adapted for arrangement in series and/or parallel. This, in combination with an improved filter head arrangement, allows different filter units to be assembled into a filtration plant, simply and for optimum performance but at relatively low cost. Further, a membrane filter body may be used that is manufactured a relatively low cost. Moreover, providing a filtration system with reversible flow direction, in combination with flow mixture regulation methods, it has been found, yields optimum cleaning of a fluid that minimizes bacterial growth on filter elements as well as build up of deposits and impurities.

The present invention presents a simple, practical and reliable filtration system with filter components that may be connected directly to one another, without the need for external piping. This filter arrangement, by use of different filter heads configurations, also allows user-selected, custom assembly of a filtration plant, simply, effectively, economically and for optimum performance.

Various modifications and alterations to the present invention may be appreciated based on a review of this disclosure. These changes and additions are intended to be within the scope and spirit of this invention as defined by the following claims.

What is claimed is:

1. A system for filtering fluids, which comprises:
a plurality of filter units, each unit including a membrane filter body with a plurality of filter elements;
connecting elements for joining the filter elements end to end and coaxially to one another;
an outer shell for housing the joined elements, the elements having peripheral portions configured for snug engagement within the outer shell;
members at opposing ends of each unit forjoining the units in series and end to end, each member including a filter head;
a clamp associated with each filter head having interior peripheral edges for engaging cooperating peripheral grooves in a corresponding end member of the filter unit; and
a ring gasket inside the clamp such that the tightness of the connection between the filter head and the respective end member increases with increasing pressure in the filter unit.

2. The system set forth in claim 1 wherein the filter element includes a spiral membrane.

3. The system set forth in claim 1 wherein the filter element includes a microtube membrane.

4. The system set forth in claim 1 wherein the outer shell comprises a layer of glass fiber covered by a layer of molded resin.

5. A system for filtering fluids, which comprises:
a plurality of filter units, each unit including a membrane filter body with a plurality of filter elements;
connecting elements for joining the filter elements end to end and coaxially to one another;
an outer shell for housing the joined elements, the elements having peripheral portions configured for snug engagement within the outer shell;
members at opposing ends of each unit for joining the units in series and end to end, each member including a filter head;
a clamp associated with each filter head, the clamp having a U section with interior peripheral edges for engaging cooperating peripheral grooves in a corresponding end member of the filter unit; and
a ring gasket inside the clamp such that the tightness of the connection between the filter head and the respective end member increases with increasing pressure in the filter unit;
each filter head being formed in two cylindrical parts, the first part having an exterior radial duct and being connected coaxially to the filter unit, the second part being closed off at one end and, at the opposite end, having an exterior axial duct in communication with inside portions of the filter unit via an interior axial conduit, and joined coaxially to the first part, the two parts held together by the clamp.

6. The system set forth in claim 5 wherein the filter element includes a spiral membrane.

7. The system set forth in claim 5 wherein the filter element includes a microtube membrane.

8. The system set forth in claim 5 wherein the outer shell comprises a layer of glass fiber covered by a layer of molded resin.

9. A system for filtering fluids, which comprises:
a plurality of filter units, each unit including a membrane filter body with a plurality of filter elements;
connecting elements for joining the filter elements end to end and coaxially to one another;
an outer shell for housing the joined elements, the elements having peripheral portions configured for snug engagement within the outer shell;
members at opposing ends of each unit forjoining the units in series and end to end, each member including a filter head;
a clamp associated with each filter head, the clamp having a U section with interior peripheral edges for engaging cooperating peripheral grooves in a corresponding end member of the filter unit; and
a ring gasket inside the clamp such that the tightness of the connection between the filter head and the respective end member increases with increasing pressure in the filter unit;
each filter head being formed as a single part, the part having an exterior radial duct, being closed off at one end, and joined coaxially to the filter unit.

10. The system set forth in claim 9 wherein the filter element includes a spiral membrane.

11. The system set forth in claim 9 wherein the filter element includes a microtube membrane.

12. The system set forth in claim 9 wherein the outer shell comprises a layer of glass fiber covered by a layer of molded resin.

13. A filter unit which includes a generally cylindrically shaped, membrane filter body comprising a plurality of filter elements, connecting elements for joining the filter elements end to end and coaxially to one another, and a relatively rigid outer shell for housing the joined elements, the shell comprising a glass fiber with a layer of resin molded thereon, peripheral portions of the elements being configured for snug engagement within the outer shell, and an outer surface of each unit end having a corresponding peripheral slot for joining one filter unit to another so as to permit the ingress and egress of fluid through a series of connected units.

14. A filter unit which includes:
a generally cylindrically shaped, membrane filter body comprising a plurality of filter elements;
connecting elements for joining the filter elements end to end and coaxially to one another;
a relatively rigid outer shell for housing the joined elements, the elements having peripheral portions configured for snug engagement within the outer shell,
a filter head at each of the opposing ends of each unit for joining the units;
a clamp associated with each filter head having interior peripheral edges for engaging cooperating peripheral grooves in a corresponding end member of the filter unit; and
a ring gasket inside the clamp such that the tightness of the connection between the filter head and the respective end member increases with increasing pressure in the filter unit;
each filter head having a first cylindrical part with an exterior radial duct and connected coaxially to the filter unit, and a second cylindrical part closed off at one end and, at the opposite end, an exterior axial duct in communication with inside portions ofthe filter unit through an interior axial conduit, and joined coaxially to the first part, the first and second parts being held together by the clamp.

15. A filter unit which includes:
a generally cylindrically shaped, membrane filter body comprising a plurality of filter elements;
connecting elements for joining the filter elements end to end and coaxially to one another;
a relatively rigid outer shell for housing the joined elements, the elements having peripheral portions configured for snug engagement within the outer shell;
a filter head at each of the opposing ends of each unit for joining the units;
a clamp associated with each filter head having interior peripheral edges for engaging cooperating peripheral grooves in a corresponding end member of the filter unit; and
a ring gasket inside the clamp such that the tightness of the connection between the filter head and the respective end member increases with increasing pressure in the filter unit;
each filter head being formed as a single part, the part having an exterior radial duct, being closed off at one end, and joined coaxially to the filter unit.

16. A system for filtering fluids, which comprises:
a plurality of filter units, each unit including a membrane filter body with a plurality of filter elements;
connecting elements forjoining the filter elements end to end and coaxially to one another;
an outer shell for housing the joined elements, the elements having peripheral portions configured for snug engagement within the outer shell;
members at opposing ends of each unit forjoining the units in series and end to end, each member including a filter head;
a clamp associated with each filter head having interior peripheral edges for engaging cooperating peripheral grooves in a corresponding end member of the filter unit; and
a ring gasket inside the clamp such that the tightness of the connection between the filter head and the respective end member increases with increasing pressure in the filter unit;
at least one of the filter units having a filter head formed as a single part, the part having an exterior radial duct, being closed off at one end, and joined coaxially to the filter unit, and
at least one of the filter units having a filter head joined coaxially to the filter unit and having a first cylindrical part with an exterior radial duct, a second cylindrical part joined coaxially to the first part and closed off at one end, and, at the opposite end, an exterior axial duct in communication with inside portions of the filter unit through an interior axial conduit, the first and second parts being held together by the clamp.

17. A method for filtration of a fluid, the method comprising the steps of:
i. directing a fluid flow in a first direction, the fluid passing through a first group of filter assemblies, the first group including a plurality of filter units, each unit having a series of membrane filter elements linked by connecting elements and filter heads;
ii. passing the fluid filtered by step i through a second group of filter assemblies, the second group including a plurality of filter units;
iii. passing the fluid filtered by step ii through a third filter assembly, the third assembly including a plurality of filter units; and
iv. directing the fluid flow in a direction opposite the first direction, the fluid passing.

18. A method for re-circulation filtration, which comprises the steps of:
i. arranging a plurality of filter assemblies in parallel for receiving a flow of fluid;
ii. directing a fluid flow in a first direction so as to direct the fluid through at least one of the filter assemblies; and
iii. directing the fluid flow in a reverse direction, back through the at least one filter assembly so as to prevent bacterial growth as well as the accumulation of waste deposits and impurities on the filter assemblies.

19. A method for re-circulation filtration and regulated flow mixing, the method comprising the the steps of:
i. arranging a plurality of filter assemblies in parallel for receiving a flow of fluid, each assembly including a series of filter units and each unit having a plurality of two filter elements linked by connecting elements and filter heads;
ii. directing a fluid flow in a first direction so as to direct the fluid through at least one of the filter assemblies;
iii. positioning valves at selected points of the filter assemblies to allow introduction and mixing of fluid flow supplied from several different entry points, and thereby allow a user to adjust the filter system for optimum balance of fluid flow.
